(19) United States
(12) Patent Application Publication
(10) Pub. No.: US 2014/0223364 A1
(43) Pub. Date: Aug. 7, 2014

(54) METHOD AND DEVICE FOR CREATING DIRECT INDEX OF CONTENT

(71) Applicant: MIIICASA TAIWAN INC., Taipei (TW)

(72) Inventors: Chih-Chiang Lin, Taipei (TW); Hsiao-Yun Chen, Taipei (TW); Chi-Hsiu Huang, Taipei (TW); Yu-Hsiang Wang, Taipei (TW)

(73) Assignee: MIIICASA TAIWAN INC., Taipei (TW)

(21) Appl. No.: 13/760,575

(22) Filed: Feb. 6, 2013

(51) Int. Cl. G06F 3/0484

(52) U.S. Cl. CPC G06F 3/04842
USPC 715/810

(57) ABSTRACT

The invention provides a method and a device for creating direct index for contents, such as webpage, local file or application, or TV channel. Through displaying first interface component comprising information of contents and a selecting component on a screen, a user may select a content to create a direct index for and input an index through a second interface on the screen comprising information of selected content and an index-input component. As a result, a customized direct index for the selected content may be created through two simple steps, by the corresponding content will be accessed by inputting the direct index. The invention reduces the steps for accessing contents and expands the flexibility of creating index of content by providing the possibility of creating direct index for contents with different types and from different sources.

### FIELD OF THE INVENTION

The present invention relates generally to a method for creating content index for digital computers, interactive televisions or any product in the smart display device field. The method may also be used on set-top boxes, televisions or any other smart display device that has Internet access. More specifically, the present invention relates to a method to help users create customized direct content index for smart display devices.

### BACKGROUND OF THE INVENTION

Current digital televisions, set-top boxes or other smart display devices (such as smart phones, desktops, laptops or tablet PCs) all support to display multiple service contents. Generally, when a user wants to choose a specific content, such user needs to open the content list (such as channel list or my favorite list), and browse within the content list to choose the webpage, document, audio/video file, or the application that the user desires to open.

However, the current technology requires such user to open the content list and then operate or browse the content list before such user can choose the specific content, which requires comparatively more steps and this is less straightforward. In addition, the setting method for the traditional content index requires the user to go through a few non-necessary steps. For example, the user may be required to open a directory hierarchy to choose a directory to categorize the selected file in order to setup the content index successfully. In another example, the user-selected service content may be matched with a predetermined channel list. As a result, the user cannot easily customize a direct content index (such as the channel number).

According to the above, what is needed is a method or a smart display device using such method for resolve the issue of the user having to open a content list before appointing a specific service content to ta specific content index. Therefore, the trouble of complex operation steps or the issue of not being able to setup and customize direct content indexes easily may be resolved.

### BRIEF SUMMARY OF THE INVENTION

The invention provides a method for creating direct index for contents, such as webpage, local application or specifically formatted document (such as image, audio file or video file), or wired or wireless television channel, and a device using such method. The method includes the steps of displaying on a screen a first interface component, which includes content information and a selecting component. The user may mark and choose the content information via the selecting component. In addition, the user may input customized string information (such as a number, or a combination or numbers and English characters) via a second interface component, which includes the content information and an index-input component, displayed on the screen. Accordingly, direct indexes can be created according to the address information (such as web address, data path or television channel) of the user selected content and the index value. As a result, the user may create a customized content index by only two simple steps. In addition, the user may, by inputting such index value, access the content according to the address of the content and display such content on the screen. The issue of the user not being able to setup and use a customized content index easily may accordingly be resolved. The present method may be applied on devices connectable to a display, such a desktops, laptops, tablet computers, smart phones or personal digital assistants (PDAs). The present method is specifically suitable for smart television, set-top box, or automobile smart system that's connected to a central control of a car.

In one embodiment, the device applying the present method may further be connected to an image capturing device for capturing user gesture or motion sensing information. Such information can be used to generate corresponding index value, and a direct index may be created between the address of the content selected and such information. After the index is created, when a user inputs a substantially equivalent gesture or a body motion, the device may access the content according to the address of the content and display such content on the screen. Similarly, the device may be connected to a voice receiving device, such a microphone, and create a direct index with the user voice information received. After the index is created, when a user inputs a substantially equivalent voice instruction, the device may access the content of the corresponding content address and display such content on the screen. In another embodiment, the device may be connected to a radio frequency receiver for receiving an operation instruction from the user's wireless device (such as a remote control, a smart phone or a tablet computer). A direct index may be created between such operation instruction and the content address. After the index is created, when the user inputs a substantially equivalent instruction on the wireless device, the device may access the content corresponding to the content address and display such content on the screen.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic illustration of the electronic device according to one embodiment of the present invention;

FIG. 2 is a block diagram of the electronic device according to one embodiment of the present invention;

FIG. 3 is a schematic illustration of the electronic device according to another embodiment of the present invention;

FIG. 4 is a block diagram of the electronic device according to another embodiment of the present invention;

FIG. 5 is a network block diagram of the electronic device and the source of content according to one embodiment of the present invention;

FIG. 6 is a network block diagram of the electronic device and the source of content according to another embodiment of the present invention;

FIG. 7 is a schematic illustration of the interface component displayed by the electronic device according to one embodiment of the present invention;

FIG. 8 is a schematic illustration of the interface component displayed by the electronic device according to another embodiment of the present invention;

FIG. 9 is a schematic illustration of the interface component displayed by the electronic device according to another embodiment of the present invention;

FIG. 10 is a schematic illustration of the interface component displayed by the electronic device according to another embodiment of the present invention;

FIG. 11 is a schematic illustration of the data structure of the direct content index created by the electronic device according to one embodiment of the present invention;

FIG. 12 is a flowchart of the method for creating direct content index according to one embodiment of the present invention;

FIG. 13 is a flowchart of the method for applying the direct content index according to one embodiment of the present invention.

FIG. 14 is a schematic illustration of the structure of the interface component system according to one embodiment of the present invention.

FIG. 15 is a schematic illustration of the structure of the interface component system according to another embodiment of the present invention.

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

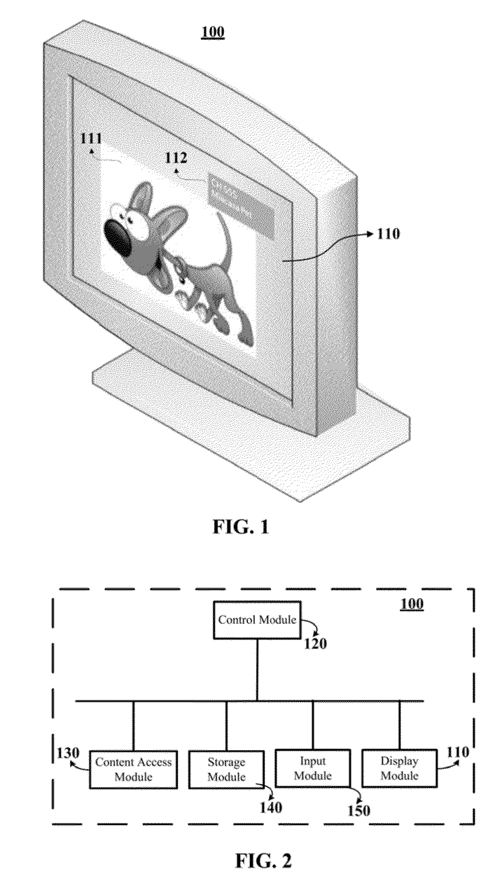

The description will be made as to the embodiments of the present invention in conjunction with the accompanying drawings in FIGS. 1-15. Reference will be made to the drawing figures to describe the present invention in detail, wherein depicted elements are not necessarily shown to scale and wherein like or similar elements are designated by same or similar reference numeral through the several views and same or similar terminology.

One embodiment of the present invention provides an electronic device for creating direct content index (hereinafter the “electronic device”). Such electronic device stores the content address of the corresponding content so as to retrieve the content according to the content address and display such content on the display screen of the electronic device. The electronic device of the present invention may create a customized direct index for the content address and retrieve the content according to the corresponding content address and display such content on the screen, when the user inputs the direct index. For example, the present invention includes embodiments that are illustrated in FIGS. 1-15.

FIGS. 1, 2 and 5 illustrate the electronic device according to one embodiment of the present invention in a schematic and a block diagram form. Referring to FIG. 1, the electronic device 100 includes a display module 110. The display module 110 includes a screen for displaying content 111 and the content related information 112. Referring to FIG. 2, the electronic device, in addition to the display module 110, may include a control module 120, a content accessing module 130, a storage module 140 and an input module 150. The content accessing module 130 may be used to retrieve contents such as webpage, wired or wireless television channels, locally stored file or application. The input module 150 may be used to receive user input information, and cause the storage module 130 to retrieve corresponding content according to the user input information and display such content on the display module 110. The user input information may include content index value such as channel numbers. Each content index value may correspond to a content address information and the content accessing module 130 may access the corresponding content according to the content address information. The storage module 140 may be used to store content index value and content address information, including web address of webpage, wired or wireless television channel, data path of locally stored file or application, and the virtual channel numbers that may map to the aforementioned web address of webpage, wired or wireless television channel, or data path of locally stored file or application. The content accessing module 130 may retrieve and display content on the display module 110 according to the content address information. The storage module 140 may further store other content related information, such as content name, content description, content thumbnail . . . etc, and the content accessing module 130 may retrieve and display the aforementioned content related information according to the content index value. The control module 120 may search the corresponding content address information in the storage module 140 according to the content index value received by the input module 150. The control module 120 may further control the content accessing module 130 to retrieve corresponding content according to the content address information, and may control the display module 110 to display such content. In addition, the control module 120 may execute an index component to generate an index value based on the second user input, and creates and stores an index of the content address and the index value. The control module 120 may also execute a switch component to control the input module to receive a third user input, and control the content accessing module to retrieve the content from the content address corresponding to the index value generated from the third user input.

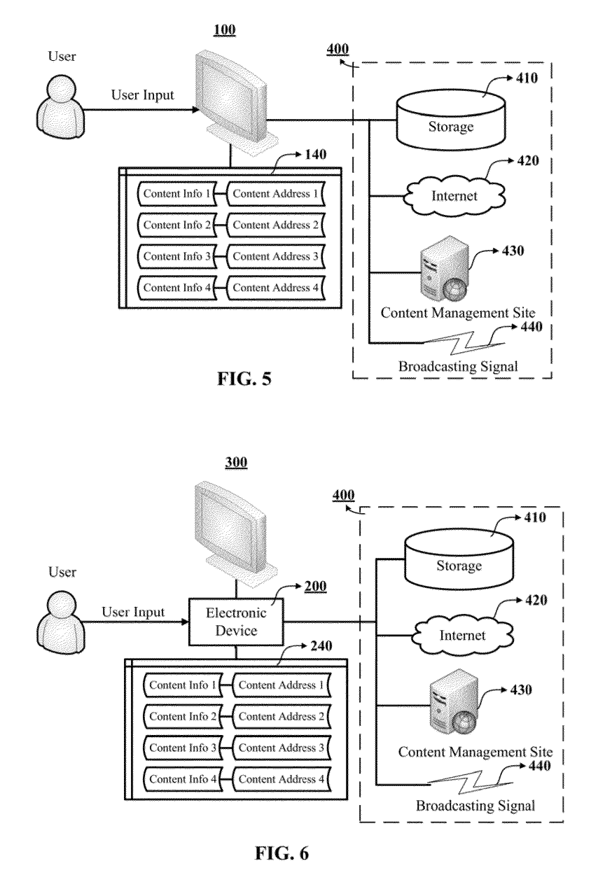

Referring to FIG. 5, the storage module 140 of the electronic device 100 stores the content information and the content address information. The content accessing module 130 may access content from the content source 400 according to the content address information. The content source 400 may include the embedded or external storage device 410 of the electronic device 100, the Internet 420, the content management website 430 or the radio broadcast signal 440. The storage device 410 may store contents such as video, image, voice file or application. The content accessing module 130 may open the file or the application according to the data path of the file or the application. The Internet 420 may include webpage or other contents of a website. The content accessing module 130 may access the corresponding website content according to the web address. The content management website 430 may be applications store, streaming video or music provider, video or music downloading website, electronic book provider (such as App Store, Google Play, Netflix, YouTube, iTunes store or Amazon Kindle). The content accessing module 130 may retrieve the login page according to the content address information. The content accessing module 130 may then provide corresponding user name and password for login. After the content download or streaming service provider's webpage is retrieved, the user may download the content or receive streaming service. The radio broadcast signal 440 primarily includes wireless and wired television channels.

The electronic device 100 of the present invention may be any device having a display module 110 for displaying content, such as a smart television or a laptop computer, a tablet computer, or a personal digital assistant (PDA). The display module 110 may include screen, and the screen may be a liquid crystal display (LCD), a cathode ray tube (CRT) screen, an organic light-emitting diode (OLED) or the like.

The control module 120 of the present invention may be a processor or a controller for executing the program instruction in the memory. The control module 120 may further include an embedded system or an application specific integrated circuit (ASIC) having embedded program instructions.

The content accessing module 130 may include storage device access interface, network communication interface or radio frequency (RF) receiver. The storage device access interface is used to access the application or file in the storage device 410 according to the data path of the application or the file. The network communication interface is used to connect to the Internet 420, so as to access the content of the website corresponding to the network address information, or to further login to the content management website 430 to access content thereof. The RF receiver is used to receive radio broadcast signal 440 corresponding to the channel number.

The storage module 140 of the present invention may be a computer readable recording medium embedded in the electronic device 100. Such storage module 140 may include ROM, RAM, EPROM, EEPROM, hard disk, solid state drive, soft disk, CD-ROM, DVD-ROM or other forms of electronic, electromagnetic or optical recording medium. Such storage module 140 may further include interfaces that can access the aforementioned computer readable recording medium to enable the electronic device 100 to connect and access such computer readable recording medium. The storage module 140 may further include network accessing device to enable the electronic device 100 to connect and access the content information and the content address information in an electronic program guide (EPG) server or a content management server.

The input module 150 of the present invention includes an input interface, which may include a radio frequency receiver or a physical interface. The radio frequency receiver may be used to receive the radio signal of a radio device, such the radio signal from a remote control, or the wireless local area network (WLAN) signal from a smart phone, a tablet computer or other wireless devices. Such radio signal or WLAN signal may be transformed into user input information. The physical interface is compatible with wired input devices, such as a keyboard, a touch-sensing device, an image capturing device, a voice receiving device or a brain wave receiving device. The aforementioned input device may receive and retrieve user input control signal, touch sensing signal, image signal, voice signal or brain wave signal, and transform them into control information, touch sensing information, voice information or brain wave information to be inputted into the electronic device 100 through the input module. Accordingly, the control module 120 may generate user input information.

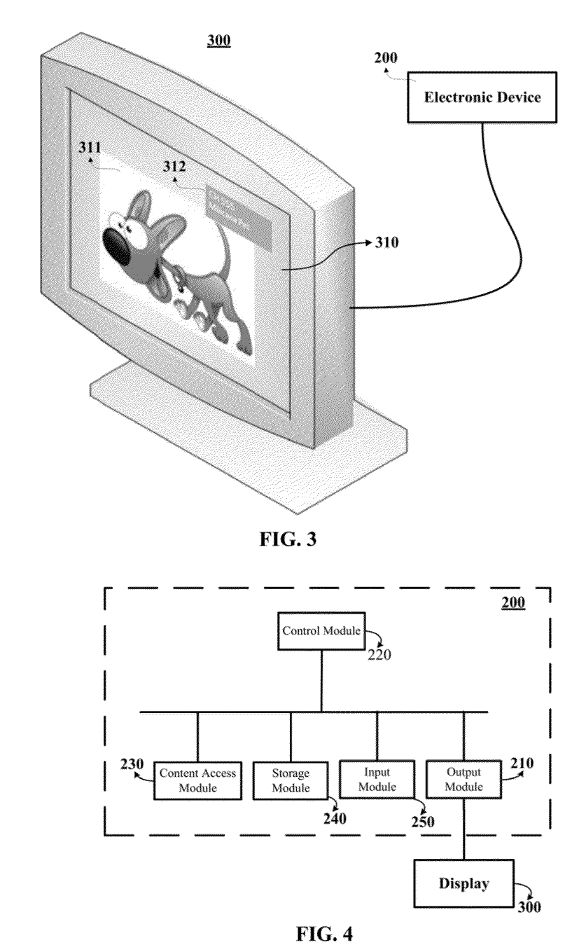

FIGS. 3, 4, and 6 illustrate the electronic device according to another embodiment of the present invention in a schematic and a block diagram form. Referring to FIG. 3, the electronic device 200 may be connected to a display device 300. The display device 300 may include a display 310 for displaying the content 311 and the content related information 312. Referring to FIG. 4, the electronic device 200 may include output module 210, control module 220, content accessing module 230, storage module 240 and the input module 250. The output module may be used to connect to the display device 300. The content accessing module 230 may be used to retrieve content 230. The input module 250 may be used to receive user input information, which includes content index value. Each content index value may match to one content address information and the content accessing module 230 may access content corresponding to the content address information. The storage module 240 may be used to store the content index value and the content address information. The content accessing module 230 may retrieve content according to the content address information and have the output module 210 output such content to the display device 300. The storage module 240 may further store content related information, which may be retrieved by the content accessing module 230 according to the content index value and outputted to the display device 300 through the output module 210. The control module 220 may search in the storage module 240 content address information corresponding to the content index value in the user information received by the input module 250. The control module 220 may further control the content accessing module 230 according to retrieve content corresponding to the content address information, and control the output module 210 to output such content to the display device 300. In addition, the control module 220 may execute an index component to generate an index value based on the second user input, and creates and stores an index of the content address and the index value. The control module 220 may also execute a switch component to control the input module to receive a third user input, and control the content accessing module to retrieve the content from the content address corresponding to the index value generated from the third user input.

Referring to FIG. 6, the electronic device 200 may store content information and content address in the storage module 240. The content accessing module may access content from the content source 400, and such content may be outputted to the display device 300 through the output module 210. The content source 400 may include an embedded or external storage device 410 of the electronic device 200, the Internet 430, a content management website 430 or a radio broadcast signal 440.

The electronic device 200 may be a set-top box. Moreover, the electronic device 200 may be an embedded system connected to the screen device 300. Such embedded system may include, but not limited to, an automobile smart system that's connected to a central control of a car. The display device 300 of the present invention may be a liquid crystal display (LCD), a cathode ray tube (CRT) screen, an organic light-emitting diode (OLED) or the like. Still, it should be reasonable to a person having ordinary skill in the art to realize that the display device 300 may also be a projecting device such as a projector or an automobile head-up display.

The control module 220 of the present invention may be a processor or a controller for executing the program instruction in the memory. The control module 220 may further include an embedded system or an application specific integrated circuit (ASIC) having embedded program instructions.

The content accessing module 230 may include storage device access interface, network communication interface or radio signal receiver. The storage device access interface is used to access the application or file in the storage device 410 according to the data path of the application or the file. The network communication interface is used to connect to the Internet 420, so as to access the content of the website corresponding to the network address information, or to further login to the content management website 430 to access content thereof. The radio signal receiver is used to receive radio signal 440 corresponding to the channel number.

The storage module 240 of the present invention may be a computer readable recording medium or an interface compatible to the aforementioned computer readable recording medium embedded in the electronic device 100 so as to enable the electronic device 200 to connect and access the aforementioned computer readable recording medium. The storage module 240 may further include a network accessing device to enable the electronic device 200 to connect and access the content information and the content address information in the electronic program guide (EPG) server or the content management server.

The input module 250 of the present invention includes an input interface, which may include a radio frequency receiver or a physical interface. The radio frequency receiver may be used to receive the radio signal of a radio device, such the radio signal from a remote control, or the wireless local area network (WLAN) signal from a smart phone, a tablet computer or other wireless devices. Such radio signal or WLAN signal may be transformed into user input information. The physical interface is compatible with wired input devices, such as a keyboard, a touch-sensing device, an image capturing device, an voice receiving device or a brain wave receiving device. The aforementioned input device may receive and retrieve user input control signal, touch sensing signal, image signal, voice signal or brain wave signal, and transform them into control information, touch sensing information, voice information or brain wave information to be inputted into the electronic device 200 through the input module. Accordingly, the control module 220 may generate user input information.

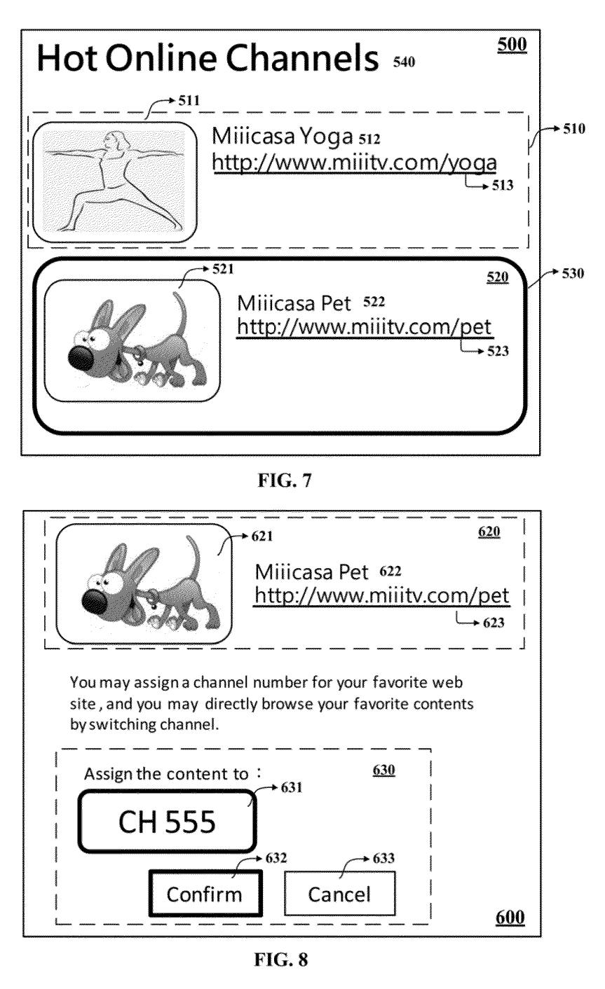

FIGS. 7-10 illustrate the interface component displayed by the electronic device's creating content index according to one embodiment of the present invention.

Referring to FIG. 7, the electronic device 100, 200 of the present invention may display a first interface component 500 at the screen 110, 310 for a user to select a content to create direct content index thereof via the input module 150, 250. The first interface component 500 may include multiple content information, (such as a first content information 510 and a second content information 520) and a selecting component 530 for selecting the content information. The first interface component may further include other information 540 such as a first interface component name. The content information such as the first content information 510 and the second content information 520 may be arranged vertically or horizontally. In addition, the selecting component 530 may mark the content currently selected. The first content information 510 and the second content information 520 may respectively include content thumbnail 511 or 521, content name 512 or 522, and content address 513 or 523. The content information 510, 520 may be stored in the storage module 140, 240 (as illustrated in FIG. 2 or 3), and may be accessed by the content accessing module 130, 230 to be displayed at the first interface component 500.

Referring to claim 8, the electronic device 100, 200 of the present invention may display a second interface component 600 at the display 110, 310 for the user to create direct content index for the content selected. The second interface component 600 may include the selected content information 620 and an index-input component 630. The content information 620 may be a content information selected by the user via the first interface component 500, and may include a thumbnail 621, a content title 622, a content address information 623 or other content related information. The index-input component 630 may include an index input column 631 for displaying the index value inputted by the user via the input module 150, 250. The index-input component 630 may further include an confirm button 632 and a cancel button 633 for the user to confirm or cancel the index value inputted.

The user may confirm the index value via the input module 150, 250 so the control module 120, 220 may control the storage module 140, 240 to store the confirmed index value. For example, when the user inputs string “555” via the input module 150, 250, the string “555” will be displayed at the index input column 631. After the user selects the confirm button 632 via the input module 150, 250, the storage module 140, 240 may store the index value “555” to the column corresponding to the selected content.

The index value may be any type of string, and may include combinations of Arabic numerals, English characters and specific characters. The electronic device 100, 200 may receive different user input information via the input module 150, 250 according to the input device connected. Thereafter, the control module 120, 220 may transform the user input information into index value. For example, the input module 150 may be connected to an image capturing device, which may capture image and recognize motion sensing information. Thereafter, the control module 120 may transform the motion sensing information into index value. Alternatively, after the image capturing device captures an image, the control module 120 may transform such image into motion sensing information to be further transformed into the index value. In another embodiment, the input module 150 may be connected to an voice receiving device (such as a microphone). After the voice receiving device receives and recognizes voice information and generates the string, the control module 120 may transform such string into an index value. Alternatively, after the voice receiving device receives the voice information, the control module 120 may transform such voice information into a string having the index value so as to retrieve the index value therein. In another embodiment, the input module 150 may be a radio frequency receiver for receiving the radio signal inputted by a wireless device (Such as a smart phone or a tablet computer) or a remote control. Afterwards, the control module 120 may transform the radio signal into the user input information and retrieve the index value therein. it should be reasonable to a person having ordinary skill in the art to realize that in addition to the aforementioned index value, the electronic device 100, 200 of the present invention may, following the aforementioned method, receive other user input information via input device connected and cause the control module 120 to execute operation instructions corresponding to the user input information.

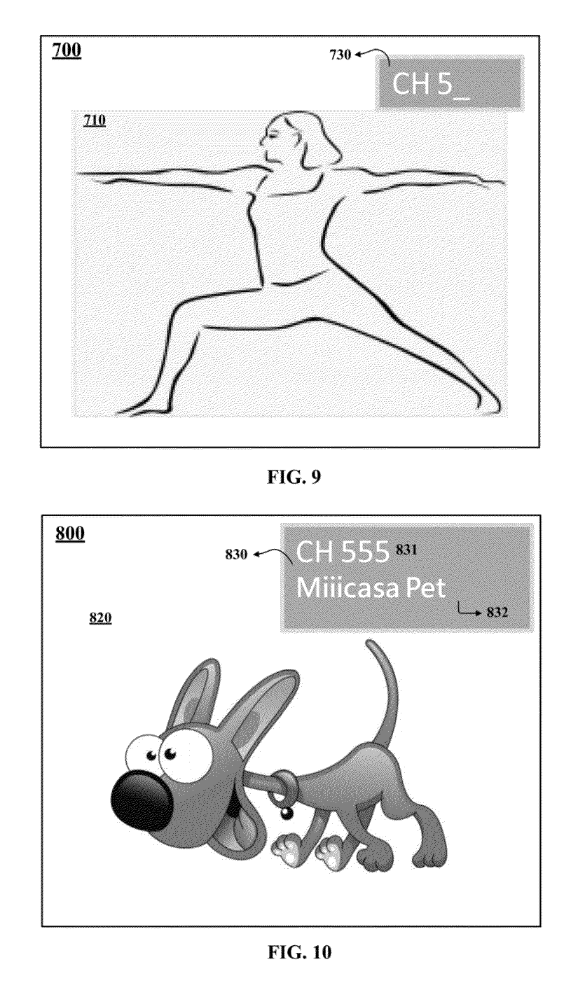

Referring to FIGS. 9 and 10, when a screen image 700 is displayed at the display 110, 310, the electronic device 100, 200 of the present invention may receive, via the input module 150, 250, index value inputted by the user, and may retrieve the content corresponding to the index value and display the content screen image 800. The screen image 700 includes the content 710 being displayed. During the process of receiving index value inputted by the user, the electronic device 100, 200 may display a third interface component 730 in the screen image 700. The third interface component 730 may include at least part of the index value inputted by the user. Furthermore, the electronic device 100, 200 may cause the control module 120, 220 to search in the storage module 140, 240 the content address information corresponding to the index value according to the index value inputted by the user. Moreover, the electronic device 100, 200 may control the content accessing module 130, 230 to retrieve from the corresponding content source 400 the content 820 according to the content address information and display such content 820 at the display 110, 310. In addition to the content 820, the electronic device 100, 200 may further access the content information 830 corresponding to the index value in the storage module 140, 240. The content information 830 may include a content index value 831, a content name 832, and may be displayed in the content image 800 together with the content 820.

In one embodiment, the index value illustrated in FIGS. 9 and 10 are the index value illustrated in FIGS. 7 and 8. A user, at the screen image 700 in FIG. 9, may input the user information, which is substantially equivalent to the input index value inputted in FIG. 8, via the input device connected to the input module 150, 250. In addition, the control module 120, 200 may transform the aforementioned user information into a value equivalent to the index value in FIG. 8. Accordingly, the user information may match with a same content address information so as to allow the content selected in FIG. 7 to be retrieved. The aforementioned word “substantially equivalent” is used because it is difficult for a user to input a completely same analog signal (such as image signal or voice signal) to the input device connected to the input module 150, 250, especially when the input device is a device for retrieving analog signals (such as an image capturing device or an voice control device). However, such signal may be recognized by specific algorithms as a same digital information (such as a motion sensing information or a voice information) and transformed by the control module 120, 220 into a same string value or operation instructions. Accordingly, such user input information is described to be “substantially equivalent.”

The electronic device 100, 200 illustrated in FIGS. 1-10 may enable a user to first select the content to be created an index thereof via the first interface component 500, and then create direct content index via the second interface component 600. The direct content index may be inputted at any screen image 700 to cause the electronic device 100, 200 to display corresponding content image 800. Comparing to the traditional way of opening a content through selecting in a content list or using a predetermined channel list, the electronic device 100, 200 of the present invention may enable the user to create a customized content index value using only two steps. Furthermore, by inputting the content index value directly, the user may cause the electronic device 100, 200 display the corresponding content image 800 directly. As a result, the steps of for a user to select a channel and access a content may be reduced. In addition, more flexibility may be provided as a direct content index may be created for different types or different sources of content.

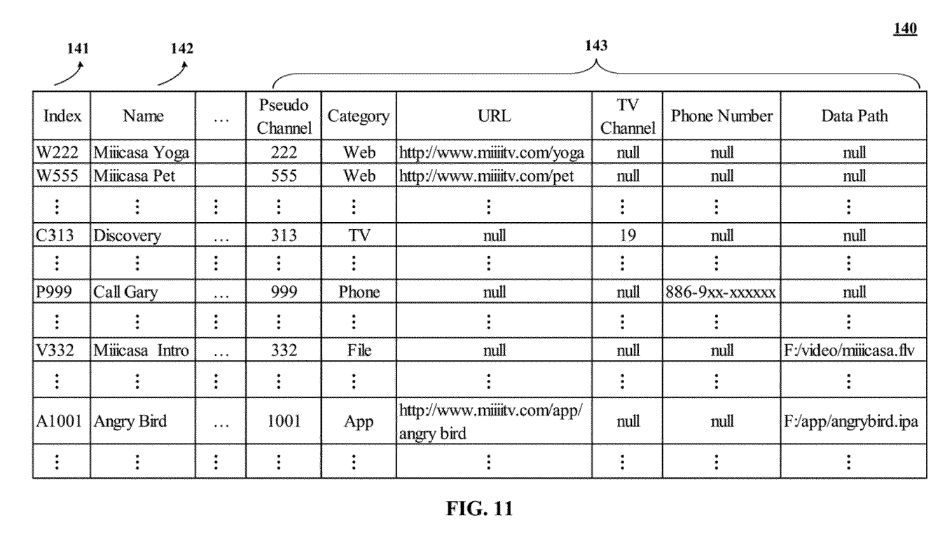

FIG. 11 is a schematic illustration of a data structure of the electronic device creating direct content index according to one embodiment of the present invention. The data stored in the storage module 140 is displayed by a table of a relational database. The column of the table may include the content related information 142 (such as the value 141 or the index value or the content name) and content address information 143. The content address information 143 may include content type and corresponding addresses of different types of content. For example, the content address information 143 may include: web address of web pages of “Miiicasa Yoga” or “Miiicasa pet”, data paths of the application “Angry Bird” or the video file “Miiicasa Intro”, a phone number of a phone call, a television channel number of the TV channel “discovery”, or the virtual channel mapping the aforementioned address information (such as channel 222, 555, 313, 999, 1001 and so on). Each row may include a record of an index value 141, a content related information 142 or a content address information 143. The index value 141 may also serve as a key for the table. Still, it should be reasonable to a person having ordinary skill in the art to realize that the data stored in the storage module may not be a relational database. FIG. 11 merely depicts the relational data base to enable a person having ordinary skill in the art to understand the invention. In addition to relational database, the storage module 140 of the present invention may include network model, object model or hierarchical model to store the index value 141, the content related information 142 and the content address information 143 of each content. By applying the data structure illustrated in FIG. 11, the electronic device 100, 200 of the present invention may create customized direct index for contents of differ type and different source.

The present invention also provides a method having a series of steps to enable the electronic device 100, 200 create direct index for content and store such direct index in the storage module 140, 240. Furthermore, the electronic device 100, 200 may apply the direct index created by the aforementioned method (hereinafter the “method of the present invention”, which includes the method to create direct index and/or the method to apply the direct index). For ease of explanation, the method(s) disclosed herein (such as the flowchart and its series of steps) should be recognized as one or more embodiments of the present invention. In addition, the steps do not necessarily need to be ordered accordingly. That is, the steps may be performed in a different order, and/or the steps may be performed with other steps of the present invention at the same time. Furthermore, the method of the present invention may be programmed as a computer program product by a programming language. The computer program product may include computer source code, executable file of a computer program and so on. The aforementioned computer program may be performed by a computer, or be stored in a computer readable storage medium, such as a ROM, a RAM, an EPROM, an EEPROM, a hard disk, a solid state drive, a soft disk, a CD-ROM, a DVD-ROM or other forms of electronic, electromagnetic or optical storage medium. The computer program may be read by a computing device and executed to perform the steps within the method of the present invention.

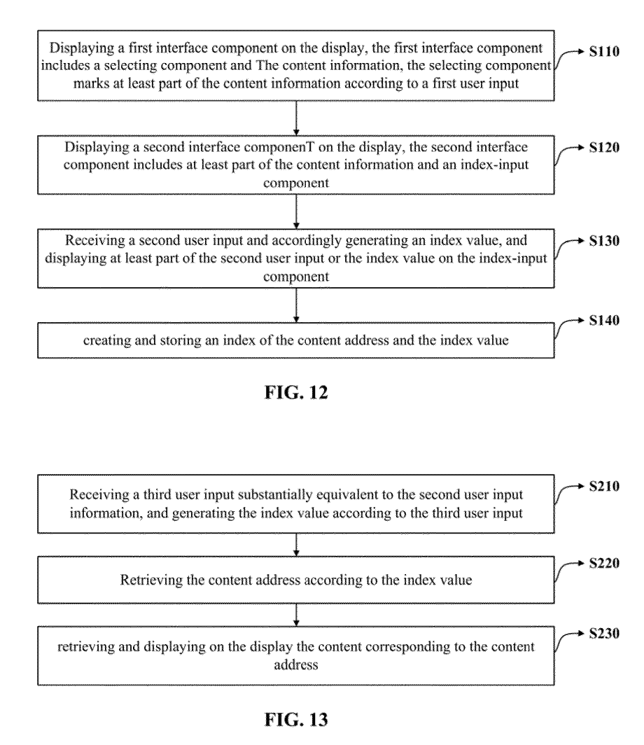

FIG. 12 is a flowchart illustrating the method for creating direct content index according to one embodiment of the method of the present invention. The method of the present invention may be applied on the electronic device 100, 200, and may perform the following steps. In step S110, a first interface component 500 is displayed. The first interface component may include a selecting component 530 and content information 510, 520. The selecting component 530 may mark at least part of the content information according to an user input. The user may select the content to be created a direct index thereof via the selecting component 530. In step S120, a second interface component 600 is displayed. The second interface component 600 may include at least part of the content information 620 and the index-input component 630. The content information 620 is part of the content information selected in step S110. In addition, the content input interface 630 may receive and display the index value inputted by the user. In step S130, a first user input is received and a index value is created accordingly. Moreover, at least part of the user input information or the index value is displayed at the index-input component 630. In step S140, an index of the content selected is created and stored according to the aforementioned index value. That is, a direct index of the aforementioned index value, content related information and the content address information is created in the storage module 140, 240.

FIG. 13 is a flowchart illustrating the method for applying direct content index according to one embodiment of the method of the present invention. The method of the present invention may be applied on the electronic device 100, 200 and may include the following steps. In step S210, a second user input is received, and an index value is created according to the second user input. In step S220, the content address information is retrieved from the storage module 140 according to the index value. In step S230, a corresponding content is retrieved from the content source 400 according to the content address information, and displayed on the display 110, 310.

The method for creating and applying direct content index illustrated in FIGS. 12 and 13 enables the user to select the content to be created an index thereof via the first interface component 500, and create direct content index via the second interface component 600. The user may further, by inputting the index value, cause the electronic device 100, 200 to display the corresponding content. As a result, the steps a user needs to access a content or open a screen image may be reduced. In addition, more flexibility may be provided for the content index as a customized direct content index may be created for different types or different sources of content.

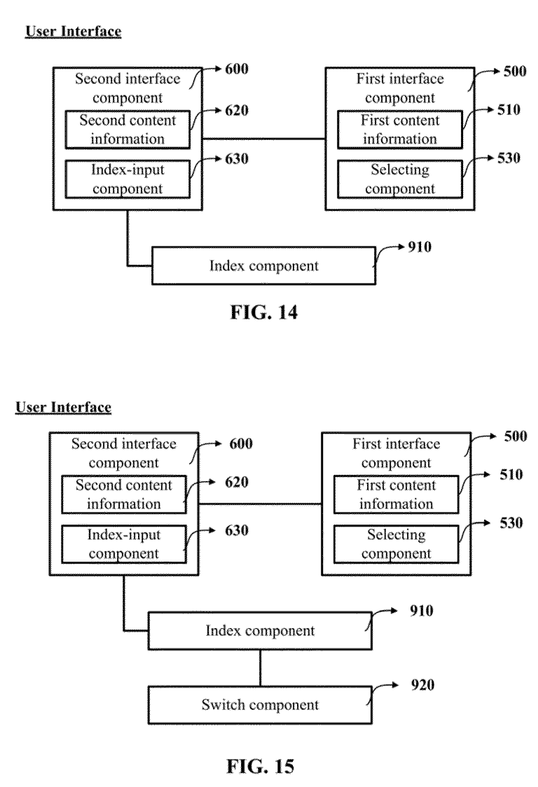

FIG. 14 is a schematic illustration of the structure of the user interface according to one embodiment of the present invention. In the present invention, the user interface may be applied to an electronic device connectable to a display such that the electronic device may create a direct content index. The electronic device may access the content and display such content on the display. In addition, the electronic device may access the content address and the content information of such content.

Referring to FIG. 14, the user interface may include a first interface component 500 and a selecting component 530. The selecting component 530 may receive a first user input inputted by a user, and accordingly select and mark at least part of one of the first content information 510. A second interface component 600 may include a second content information 620 and an index-input component 630. The content information 620 may be at least part of the first content information 510 selected and marked by the selecting component 530. The index-input component 630 may be used to receive a second user input inputted by the user. An index component 910 may be used to generate an index information according to the second user input received, and create the direct index between the content address stored and the index information.

In more detail, the second interface component 600 may further display at least part of the second user input or the index information at the index-input component 630, so as to provide the user to verify that the electronic device has received the user information and index information inputted.

The aforementioned content disclosed in the present invention may come from the embedded or external storage device of the electronic device. Such content may include image, video, audio file or application. The data path of the aforementioned file or application in the storage device may be the content address disclosed in the present invention. In addition, the content may come from the Internet, which includes contents of webpages of websites or other content of the website. Specifically, the web address of the website or webpage may be used as the content address of the present invention. Moreover, the content may come from content management websites, which include application store, streaming video or audio provider, video or audio downloading website, electronic book website, and the like. The electronic device of the present invention may login to the website according to the web address, and download the content or directly access the online streaming service. Furthermore, the content may come from radio broadcast signal, which includes wireless television channels, cable television channels, and so on.

The user input in the present invention, which includes the first user input and the second user input, may come from a radio frequency signal or an input device. The user input may further include a string, which may represent a control command or a data. To be specific, the first user input may include a string, representing the control command for controlling the selecting component to select one of the multiple contents. The second user input may include another string, which represents the index value that the user inputted. That is, the index value includes the string. For example, the second user input may include the string “555”, and therefore the index value is “555”.

FIG. 15 is a schematic illustration of the structure of the user interface according to another embodiment of the present invention. Referring to FIG. 15, the user interface may include a first interface component 500, a second interface component 600, an index component 910 and a switch component 920. The switch component 920 may be used to receive a third user input inputted by the user. The third user input is substantially equivalent to the second user input. The index component 910 may generate the index information corresponding to the second user input according to the third user input, and retrieve the content address according to the index information. Moreover, the switch component 920 may retrieve and display the content corresponding to the content address. As a result, the content may be retrieved from the electronic device by using the direct content index created, and displayed on a display.

By implementing the user interface, the user may select the content to create an index thereof via the first interface component, and input and create the index information corresponding to the content via the first interface component. Accordingly, by inputting the index information, the electronic device may access the corresponding content. As a result, the numbers of operation by the user may be reduced so as to expand the flexibility of the content index, i.e., to create customized direct content index for contents with different types and from different sources.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A user interface for a electronic device facilitating creating direct index of content through the electronic device, wherein the electronic device configured to access a content address and a content information corresponding to the content address, and the device further configured to access and display a content on a display, comprising:
a first interface component comprising a selecting component and content information, wherein the selecting component receives a first user input and marks at least a part of the content information according to the first user input;
a second interface component comprising an index-input component and at least part of the content information, wherein the index-input component receives a second user input; and
an index component that generates an index value according to the second user input, and creates and stores an index of the content address and the index value.

2. The user interface of claim 1, wherein the index value includes a string, and the second user input includes the string.

3. The user interface of claim 1, wherein the content address includes a web address, and the content includes the webpage information corresponding to the web address.

4. The user interface of claim 1, wherein the device connects to a storage device, and wherein the content address is a corresponding data path of a file or an application in the storage device.

5. The user interface of claim 1, further comprising:
a switch component that receives a third user input substantially equivalent to the second user input;
wherein the index component generates the index value according to the third user input, and retrieves the content address according to the index value; and
wherein the switch component also retrieves and displays the content corresponding to the content address.

6. A method for creating direct content index implemented on a device connected to a display, the device configured to access a content address and a content information corresponding to the content address, the device further configured to access and display a content on the display, the method comprising:
displaying a first interface component on the display, the first interface component includes a selecting component and the content information, the selecting component marks at least part of the content information according to a first user input;
displaying a second interface component on the display, the second interface component includes at least part of the content information and an index-input component;
receiving a second user input and accordingly generating an index value, and displaying at least part of the second user input or the index value on the index-input component; and
creating and storing an index of the content address and the index value.

7. The method according to claim 6, wherein the index value includes a string, and the second user input includes the string.

8. The method according to claim 6, wherein the device connects to an image capturing device, the image capturing device captures an image and accordingly generates the second user input.

9. The method according to claim 6, wherein the device connects to a voice receiving device, the voice receiving device receives a voice information and accordingly generates the second user input.

10. The method according to claim 6, wherein the content address includes a web address, and the content includes the webpage information corresponding to the web address.

11. The method according to claim 6, wherein the device connects to a storage device, wherein the content address includes a corresponding data path of a file or an application in the storage device.

12. The method according to claim 6, further comprising:
receiving a third user input substantially equivalent to the second user input information, and generating the index value according to the third user input; and
retrieving the content address according to the index value; and
retrieving and displaying on the display the content corresponding to the content address.

13. An electronic device having a display, the electronic device comprising:
a storage module for storing at least a content address and a content information corresponding to the content address;
a content accessing module for accessing content corresponding to the content address;
an input module for receiving a first user input and a second user input;
a control module for searching the content information and the content address according to the first user input information in the storage module, and for creating and storing in the storage module an index for the content address and an index value generated corresponding to the second user input; and
a display module for displaying the content accessed by the content accessing module,
wherein the control module controls the display module to display a first interface component and a second interface component of a interface component, and retrieves the corresponding content address in the storage module using the index value, and controls the content accessing module to access the corresponding content according to the content address,
wherein the first interface component includes a selecting component and the content information, the selecting component marks at least part of the content information according to the first user input,
wherein the second interface component includes at least part of the content information and a index component, the index component displays at least part of the second user input or the index information.

14. The electronic device according to claim 13, wherein the input module connects to an image capturing device, the image capturing device captures an image information to be used as the second user input; and
wherein the control module generates a motion sensing information according to the image information, and generates a string to be used as the index value according to the motion sensing information.

15. The electronic device according to claim 13, wherein the input module connects to a voice receiving device, the voice receiving device receives a voice information to be used as the second user input,
wherein the control module is further configured to generate a string to be used as the index value according to the voice information.

16. The electronic device according to claim 13, wherein the input module connects to a radio frequency receiving device, the radio frequency receiving device receives a radio frequency signal from a control device and generates a string to be used as the second user input, the control module further configured to generate the index value according to the string.

17. The electronic device according to claim 13, wherein the content address includes a web address, the content accessing module includes a communication device, wherein the communication device accesses a webpage corresponding to the web address to be used as the content corresponding to the content address.

18. The electronic device according to claim 13, wherein the content address includes a corresponding data path of a file or an application in the storage device, wherein the content accessing module receives a processing unit, and accesses the file or the application according to the data path to configure the processing unit to execute the file or the application to be used as the content corresponding to the content address.

19. The electronic device according to claim 13, wherein the input module receives a third user input substantially equivalent to the second user input information, wherein the control module utilizes the third use input to generate the index value of the second user input, and retrieves the content address corresponding to the index value from the storage module, and controls the content accessing module to access the content according to the content address.

20. An electronic device connected to a display, the electronic device comprising:
a storage module for storing at least a content address and a content information corresponding to the content address;
a content accessing module for accessing corresponding content according to the content address;
an input module for receiving a first user input and a second user input;
a control module for searching the corresponding content information and the content address according to a first user input in the storage module, and for creating and storing in the storage module an index of the content address and an index value generated corresponding to the second user input; and
an output module for outputting the content accessed by the content accessing module to the display,
wherein the control module controls the output module to output a first interface component and a second interface component to the display, and retrieves the corresponding content address using the index value in the storage module, and controls the content accessing module to access the corresponding content according to the content address,
wherein the first interface component includes a selecting component and the content information, the selecting component marks at least part of the content information according to the first user input,
wherein the second interface component includes at least part of the content information and an index component, the index component displays at least part of the first user input or the index value.

21. The electronic device according to claim 20, wherein the input module connects to an image capturing device, the image capturing device captures an image information to be used as the second user input; and
wherein the control module generates a motion sensing information according to the image information, and generates a string to be used as the index value according to the motion sensing information.

22. The electronic device according to claim 20, wherein the input module connects to a voice receiving device, the voice receiving device receives a voice information to be used as the second user input,
wherein the control module is further configured to generate a string to be used as the index value according to the voice information.

23. The electronic device according to claim 20, wherein the input module connects to a radio frequency receiving device, the radio frequency receiving device receives a radio frequency signal from a control device and generates a string to be used as the second user input, the control module further configured to generate the index value according to the string.

24. The electronic device according to claim 20, wherein the content address includes a web address, the content accessing module includes a communication device, wherein the communication device accesses a webpage corresponding to the web address to be used as the content corresponding to the content address.

25. The electronic device according to claim 20, wherein the content address includes a corresponding data path of a file or an application in the storage device, wherein the content accessing module receives a processing unit, and accesses the file or the application according to the data path to configure the processing unit to execute the file or the application to be used as the content corresponding to the content address.

26. The electronic device according to claim 20, wherein the input module receives a third user input substantially equivalent to the second user input information, wherein the control module utilizes the third use input to generate the index value of the second user input, and retrieves the content address corresponding to the index value from the storage module, and controls the content accessing module to access the content according to the content address.

27. A computer readable storage medium including instructions readable by a computer which, when implemented, cause the computer to handle information by performing the method according to claim 6.
